(19) United States
(12) Patent Application Publication
(10) Pub. No.: US 2015/0205898 A1
(43) Pub. Date: Jul. 23, 2015

(54) DESIGN METHOD AND DESIGN APPARATUS

(71) Applicant: FUJITSU SEMICONDUCTOR LIMITED, Yokohama-shi (JP)

(72) Inventors: Takaaki OKUMURA, Kunitachi (JP); Hiromi Oka, Higashiyamato (JP); Kenichi Ishiguro, Akishima (JP)

(21) Appl. No.: 14/593,829

(22) Filed: Jan. 9, 2015

(30) Foreign Application Priority Data
Jan. 20, 2014 (JP) 2014-007570

(51) Int. Cl. G06F 17/50

(52) U.S. Cl. CPC G06F 17/5059; G06F 17/5072

(57) ABSTRACT

A design apparatus preferentially selects a low coefficient in a range in which design conditions are met from a group of coefficients (coefficient library) indicative of an increase in delay time at the time of voltage drop for combinations of one of a plurality of clock buffers which differ in parameter and one of a plurality of wiring loads, which differ in parameter, connected to the one of the plurality of clock buffers, selects from the plurality of clock buffers and the plurality of wiring loads a clock buffer and a wiring load each having a parameter associated with the selected coefficient, and designs a clock path.

### CROSS-REFERENCE TO RELATED APPLICATION

This application is based upon and claims the benefit of priority of the prior Japanese Patent Application No. 2014-007570, filed on Jan. 20, 2014, the entire contents of which are incorporated herein by reference.

### FIELD

The embodiments discussed herein are related to a design method and a design apparatus.

### BACKGROUND

In recent years there has been a tendency for a power supply noise amount to increase by the influence of an increase in current density caused by the fabrication of minute semiconductor integrated circuits, an increase in power consumption caused by an increase in the speed or integration level of semiconductor integrated circuits, or the like. In addition, voltage is decreased for reducing power consumption, so the power supply noise resistance of circuits decreases. Accordingly, a design is made with power supply noise taken into consideration. For example, a noise source is kept away from elements which are susceptible to noise.

Japanese Laid-open Patent Publication No. 2011-151100

Japanese Laid-open Patent Publication No. 2011-8410

Japanese Laid-open Patent Publication No. 2006-195754

Japanese Laid-open Patent Publication No. 2005-4268

Power supply noise causes delay fluctuations on a clock path of a synchronous circuit, so a timing constraint may not be satisfied. Accordingly, for example, a clock buffer which operates at a high speed may be used on a clock path or a wiring load may be reduced. By doing so, a delay which occurs on the clock path is minimized to reduce susceptibility to power supply noise.

Even on such a clock path, however, delay time may become longer by the influence of power supply noise. As a result, a timing constraint may not be satisfied. Therefore, such a clock path does not have high power supply noise resistance.

### SUMMARY

According to an aspect, there is provided a design method including: preferentially selecting, by a processor, a low coefficient in a range in which design conditions are met from a group of coefficients indicative of an increase in delay time at a time of voltage drop for combinations of one of a plurality of clock buffers which differ in parameter and one of a plurality of wiring loads, which differ in parameter, connected to the one of the plurality of clock buffers; and selecting, by the processor, from the plurality of clock buffers and the plurality of wiring loads a clock buffer and a wiring load each having a parameter associated with the selected coefficient, and designing, by the processor, a clock path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates examples of a design method and a design apparatus according to a first embodiment;

FIG. 2 illustrates an example of calculating a noise amount;

FIG. 3 indicates an example of the correlation between simulation results and values calculated from expression (1) for the maximum value of delay fluctuations on a clock path;

FIG. 4 illustrates an example of a design apparatus according to a second embodiment;

FIG. 5 illustrates an example of a semiconductor integrated circuit including a clock path to be designed;

FIG. 6 is a flow chart for describing the flow of an example of a design method according to the second embodiment;

FIG. 7 indicates an example of the relationship between the amount of an increase in delay time and the magnitude of a voltage drop;

FIG. 8 illustrates an example of a coefficient library;

FIG. 9 illustrates an example of a group of coefficients;

FIG. 10 illustrates an example of the state of fluctuations in path delay at the time of the occurrence of noise on a clock path using clock buffers of plural types and wiring loads of plural types;

FIG. 11 illustrates an example of the relationship between the time of the occurrence of noise and the amount of a fluctuation in path delay on a clock path using clock buffers of plural types and wiring loads of plural types;

FIG. 12 illustrates an example of the state of a fluctuation in path delay at the time of the occurrence of noise on a clock path using clock buffers of the same type and wiring loads of the same type;

FIG. 13 illustrates an example of the relationship between the time of the occurrence of noise and the amount of a fluctuation in path delay on a clock path using clock buffers of the same type and wiring loads of the same type; and

FIG. 14 illustrates an example of the length of delay time corresponding to parameters.

### DESCRIPTION OF EMBODIMENTS

Embodiments will now be described with reference to the accompanying drawings, wherein like reference numerals refer to like elements throughout.

### First Embodiment

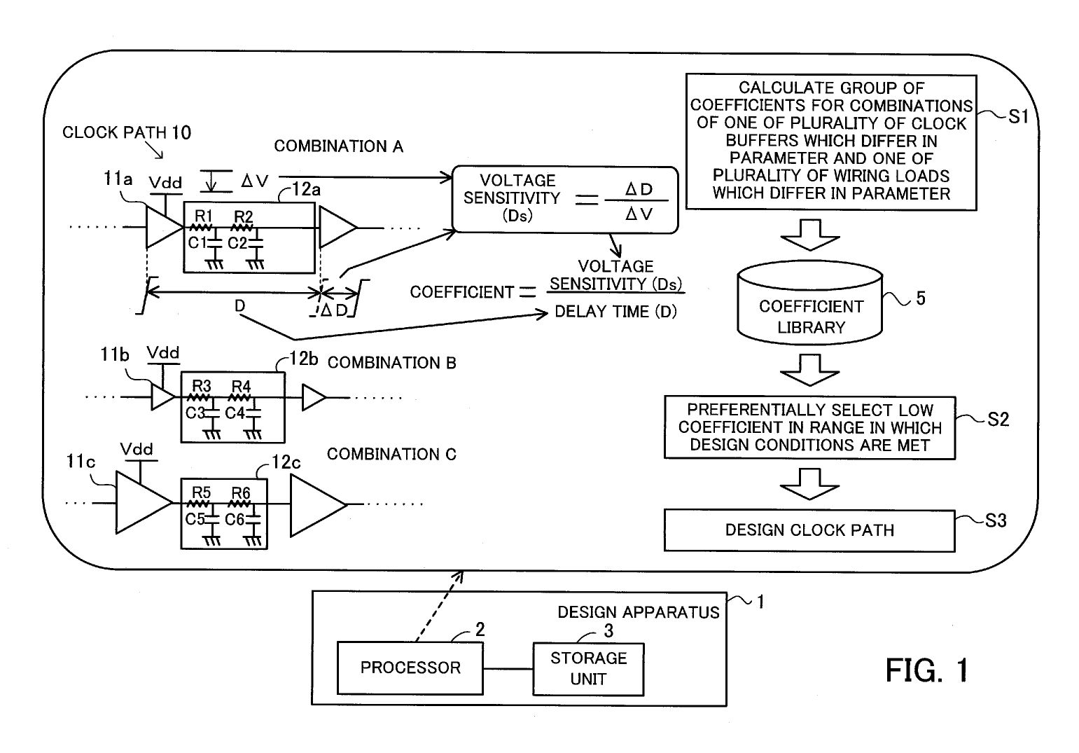

FIG. 1 illustrates examples of a design method and a design apparatus according to a first embodiment.

A design apparatus 1 includes a processor 2 and a storage unit 3. The processor 2 uses the following design method on the basis of data and a program stored in the storage unit 3.

The storage unit 3 stores a program executed by the processor 2 and various pieces of data. For example, the storage unit 3 stores a coefficient library 5 described later.

The design method according to the first embodiment is to design a clock path on which delay fluctuations caused by power supply noise are small, that is to say, a clock path which has high power supply noise resistance.

First the processor 2 calculates a group of coefficients indicative of an increase in delay time at the time of voltage drop for combinations of one of a plurality of clock buffers which differ in parameter and one of a plurality of wiring loads, which differ in parameter, connected to the one of the plurality of clock buffers (step S1).

The parameters of a clock buffer are the size of the clock buffer (size of a transistor included in the clock buffer), transistor threshold voltage, and the like.

The parameters of a wiring load are wiring width, wiring length, an interval between adjacent wirings, the type (metal 1 layer, a metal 2 layer, or the like) of a wiring layer used for a wiring, and the like.

In the example of FIG. 1, a clock path 10 is illustrated. With the clock path 10, a combination of a clock buffer 11a and a wiring load 12a connected thereto is considered as a cell at one stage. Cells which are the same as this cell are arranged at plural stages and are connected according to the length of the clock path 10.

In the example of the first embodiment it is assumed that a coefficient is expressed as

voltage sensitivity (Ds)/delay time (D),

where voltage sensitivity (Ds) is given by Ds=ΔD/ΔV, where ΔD indicates the amount of an increase in delay time corresponding to voltage drop ΔV, and D indicates delay time (cell delay time) corresponding to the above combination at one stage at the time of ideal power-supply voltage Vdd being applied. D and ΔD may change depending on the above parameters, so the coefficient is calculated, for example, by the use of a circuit simulation for each of combinations of one of a plurality of clock buffers which differ in parameter and one of a plurality of wiring loads which differ in parameter.

FIG. 1 illustrates a combination A of a clock buffer 11a and a wiring load 12a, a combination B of a clock buffer 11b and a wiring load 12b, and a combination C of a clock buffer 11c a wiring load 12c. The clock buffers 11a, 11b, and 11c differ in parameter and the wiring loads 12a, 12b, and 12c differ in parameter.

The wiring loads 12a, 12b, and 12c have wiring resistances R1 and R2, R3 and R4, and R5 and R6, respectively, and have wiring capacitances C1 and C2, C3 and C4, and C5 and C6 respectively. These values change depending on parameters such as wiring length and wiring width. Furthermore, the clock buffers 11a, 11b, and 11c differ in size. The clock buffers 11a, 11b, and 11c differ in parameter and the wiring loads 12a, 12b, and 12c differ in parameter. As a result, the combinations A, B, and C formed of them may differ in D and ΔD.

Therefore, in the example of FIG. 1, the coefficient is calculated for each of the combinations A, B, C formed of the clock buffers 11a, 11b, and 11c, which differ in parameter, and the wiring loads 12a, 12b, and 12c, respectively, which differ in parameter.

A group of the calculated coefficients is stored as the coefficient library 5, for example, in the storage unit 3.

Next, the processor 2 preferentially selects a low coefficient from the group of the coefficients within a range in which design conditions are met (step S2).

The design conditions are wiring length of a clock path, a timing condition (timing constraint) on the clock path, the type of a cell, wiring conditions (wiring layer, wiring width, and a wiring interval), and the like. In step S2, for example, a coefficient corresponding to a parameter of a clock buffer type or a wiring condition not used in design is not selected. A low coefficient is then preferentially selected from among coefficients corresponding to parameters of conditions used in design (for example, the minimum coefficient is selected).

The inventors have obtained the knowledge that the maximum value of delay fluctuations on a clock path formed by connecting the same combinations of a clock buffer having a parameter and a wiring load having a parameter which are arranged at plural stages is approximated by

Max(ΔDₚₐₜₕ)=(Ds/D)×S (1)

where Max(ΔDₚₐₜₕ) is the maximum value of delay fluctuations ΔDₚₐₜₕ on the clock path, (Ds/D) is the above coefficient, and S is the amount of noise which appears on the clock path.

A noise amount is found in the following way.

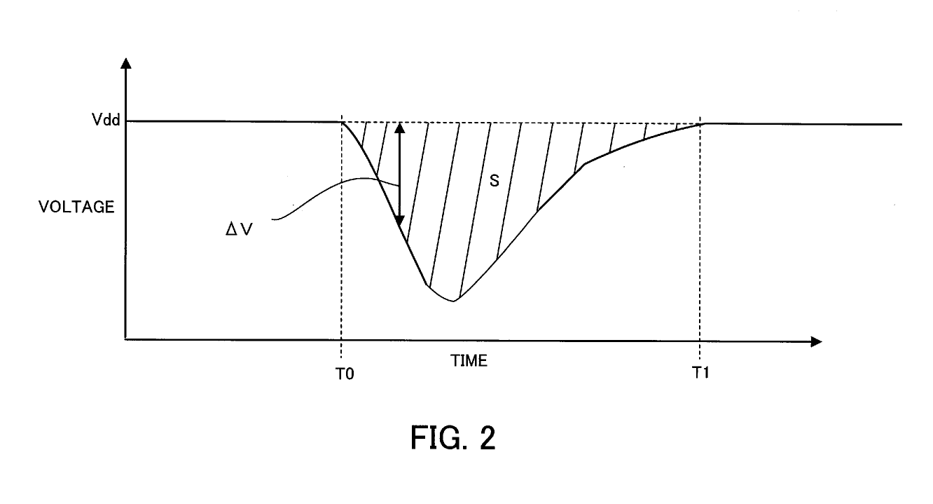

FIG. 2 illustrates an example of calculating a noise amount.

In FIG. 2, a horizontal axis indicates time and a vertical axis indicates voltage. The example of FIG. 2 indicates that noise appears on a power supply line of a clock path from timing T0 to timing T1 and that voltage drops from ideal power-supply voltage Vdd. Noise amount (S) is found by integrating the magnitude ΔV of a voltage drop from the power-supply voltage Vdd with respect to time from T0 to T1 for which noise appears.

The relationship between Max(ΔDₚₐₜₕ) found from expression (1) and Max(ΔDₚₐₜₕ) found by doing circuit simulations is as follows.

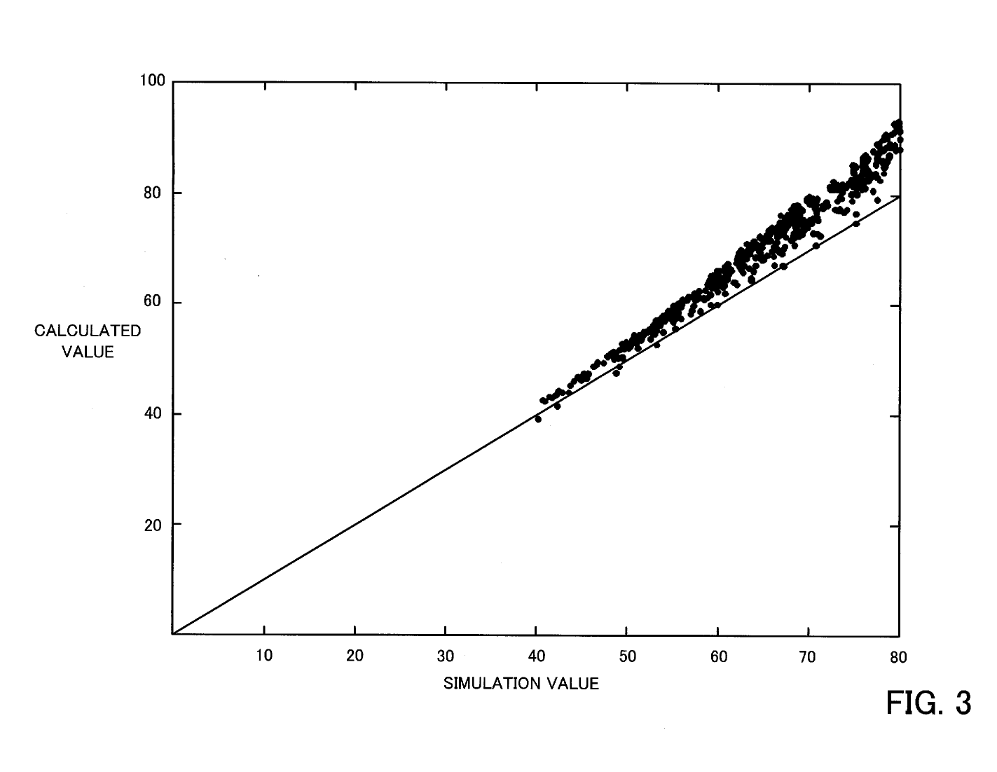

FIG. 3 indicates an example of the correlation between simulation results and values calculated from expression (1) for the maximum value of delay fluctuations on a clock path.

In FIG. 3, a horizontal axis indicates a simulation value for the maximum value of delay fluctuations and a vertical axis indicates a value calculated from expression (1) for the maximum value of delay fluctuations. The correlation between simulation values and values calculated from expression (1) for the maximum value of delay fluctuations on a clock path formed by arranging the same combinations of a clock buffer and a wiring load at 21 stages and connecting them is indicated. In this case, clock buffers which differ in parameter and wiring loads which differ in parameter are used for forming combinations.

A change in parameter causes a change in the maximum value of delay fluctuations. As indicated in FIG. 3, however, the values calculated from expression (1) for the maximum value of delay fluctuations well match the simulation values. This indicates that the maximum value of delay fluctuations on a clock path can be approximated by expression (1).

As can be seen from expression (1), the maximum value of delay fluctuations on a clock path caused by noise becomes smaller by minimizing the coefficient (Ds/D).

As described later, however, making the coefficient small leads to a long delay time. Therefore, in step S2 a low coefficient is preferentially selected within a range in which the timing constraint, which is one of the design conditions, is met. An example of determining the timing constraint will be described in a second embodiment.

After the above step S2 ends, the processor 2 performs step S3. In step S3, the processor 2 selects a clock buffer and a wiring load each having a parameter associated with the coefficient selected in step S2 from the plurality of clock buffers which differ in parameter and the plurality of wiring loads which differ in parameter. By doing so, the processor 2 designs a clock path.

As stated above, the coefficient expresses an increase in delay time at the time of voltage drop. Accordingly, a low coefficient is preferentially selected in a range in which the design conditions are met. A clock buffer and a wiring load each having a parameter associated with the coefficient are used for designing a clock path. This makes it possible to design a clock path on which an increase in delay time is slight at the time of a voltage drop caused by power supply noise, that is to say, a clock path on which great delay fluctuations are not caused by power supply noise (which has high power supply noise resistance).

Furthermore, a clock path having high power supply noise resistance is designed in the design phase. Otherwise, delay fluctuations on a clock path are verified by a circuit simulator after a placement and routing process and a placement and routing process is performed again on the basis of a verification result to make a correction. With the design method according to this embodiment such trouble is saved.

In the above example, a case where the design apparatus 1 generates the coefficient library 5 has been described. However, another method may be adopted. For example, the following method may be adopted. The design apparatus 1 acquires the coefficient library 5 generated by another apparatus and stores it in the storage unit 3. When the processor 2 designs a clock path, the processor 2 reads out the coefficient library 5 from the storage unit 3 and uses it.

### Second Embodiment

Examples of a design method and a design apparatus according to a second embodiment will now be described.

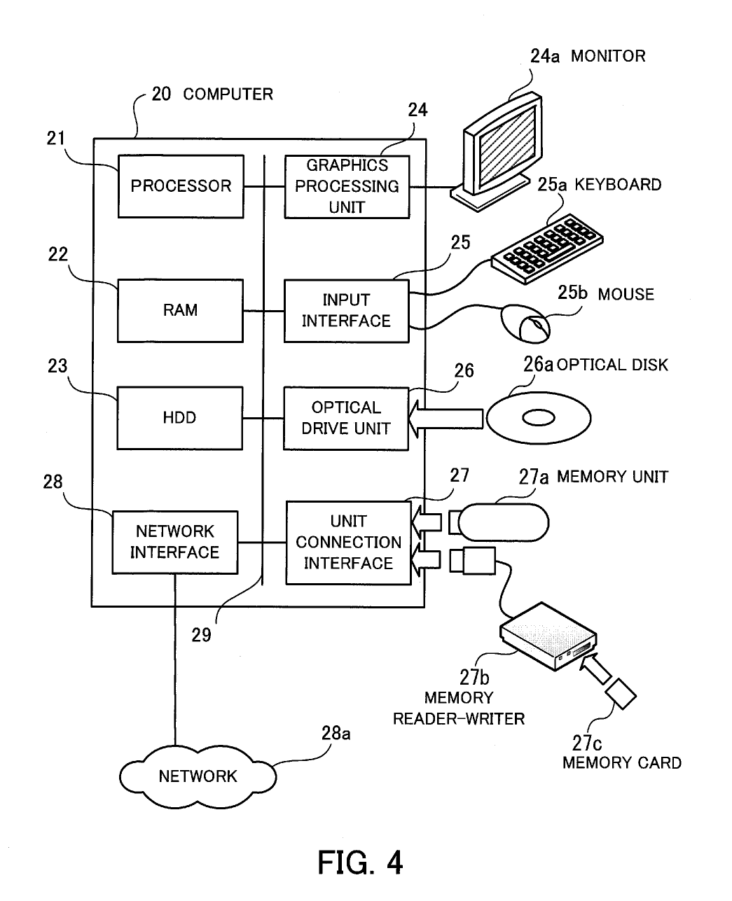

FIG. 4 illustrates an example of a design apparatus according to a second embodiment.

A design apparatus is, for example, a computer 20 and the whole of the computer 20 is controlled by a processor 21. A RAM (Random Access Memory) 22 and a plurality of peripheral units are connected to the processor 21 via a bus 29. The processor 21 may be a multiprocessor. The processor 21 is a CPU (Central Processing Unit), a MPU (Micro Processing Unit), a DSP (Digital Signal Processor), an ASIC (Application Specific Integrated Circuit), a PLD (Programmable Logic Device), or the like. Furthermore, the processor 21 may be a combination of two or more of a CPU, a MPU, a DSP, an ASIC, and a PLD.

The RAM 22 is used as main storage of the computer 20. The RAM 22 temporarily stores at least a part of an OS (Operating System) program or an application program executed by the processor 21. In addition, the RAM 22 stores various pieces of data which the processor 21 needs to perform a process.

The plurality of peripheral units connected to the bus 29 are a HDD (Hard Disk Drive) 23, a graphics processing unit 24, an input interface 25, an optical drive unit 26, a unit connection interface 27, and a network interface 28.

The HDD 23 magnetically writes data to and reads out data from a built-in disk. The HDD 23 is used as auxiliary storage of the computer 20. The HDD 23 stores the OS program, application programs, and various pieces of data. A semiconductor memory, such as a flash memory, may be used as auxiliary storage.

A monitor 24a is connected to the graphics processing unit 24. The graphics processing unit 24 displays an image on a screen of the monitor 24a in accordance with an instruction from the processor 21. The monitor 24a is a display using a CRT (Cathode Ray Tube), a liquid crystal display, or the like.

A keyboard 25a and a mouse 25b are connected to the input interface 25. The input interface 25 transmits to the processor 21 a signal transmitted from the keyboard 25a or the mouse 25b. The mouse 25b is an example of a pointing device and another pointing device, such as a touch panel, a tablet, a touch pad, or a track ball, may be used.

The optical drive unit 26 reads data recorded on an optical disk 26a by the use of a laser beam or the like. The optical disk 26a is a portable record medium on which recorded data can be read by the reflection of light. The optical disk 26a is a DVD (Digital Versatile Disc), a DVD-RAM, a CD-ROM (Compact Disc Read Only Memory), a CD-R(Recordable)/RW(ReWritable), or the like.

The unit connection interface 27 is a communication interface used for connecting peripheral units to the computer 20. For example, a memory unit 27a and a memory reader-writer 27b are connected to the unit connection interface 27. The memory unit 27a is a record medium having the function of communicating with the unit connection interface 27. The memory reader-writer 27b is a unit which writes data to or reads out data from a memory card 27c. The memory card 27c is a card-type record medium.

The network interface 28 is connected to a network 28a. The network interface 28 transmits data to or receives data from another computer or a communication apparatus via the network 28a.

By adopting the above hardware configuration, the processing functions in the second embodiment are realized. The design apparatus 1 according to the first embodiment illustrated in FIG. 1 is also realized by adopting the same hardware that makes up the computer 20 illustrated in FIG. 4.

The computer 20 realizes the processing functions in the second embodiment by executing a program recorded in, for example, a computer-readable record medium. The program in which the contents of a process that is to be performed by the computer 20 are described is recorded in various record media. For example, the program which is to be executed by the computer 20 is stored in the HDD 23. The processor 21 loads at least a part of the program stored in the HDD 23 into the RAM 22 and executes it. Furthermore, the program which is to be executed by the computer 20 may be recorded on a portable record medium, such as the optical disk 26a, the memory unit 27a, or the memory card 27c. The program recorded on a portable record medium is installed in the HDD 23 and then is executed, under the control of, for example, the processor 21. In addition, the processor 21 may read out the program directly from a portable record medium and execute it.

(Example of Object of Design)

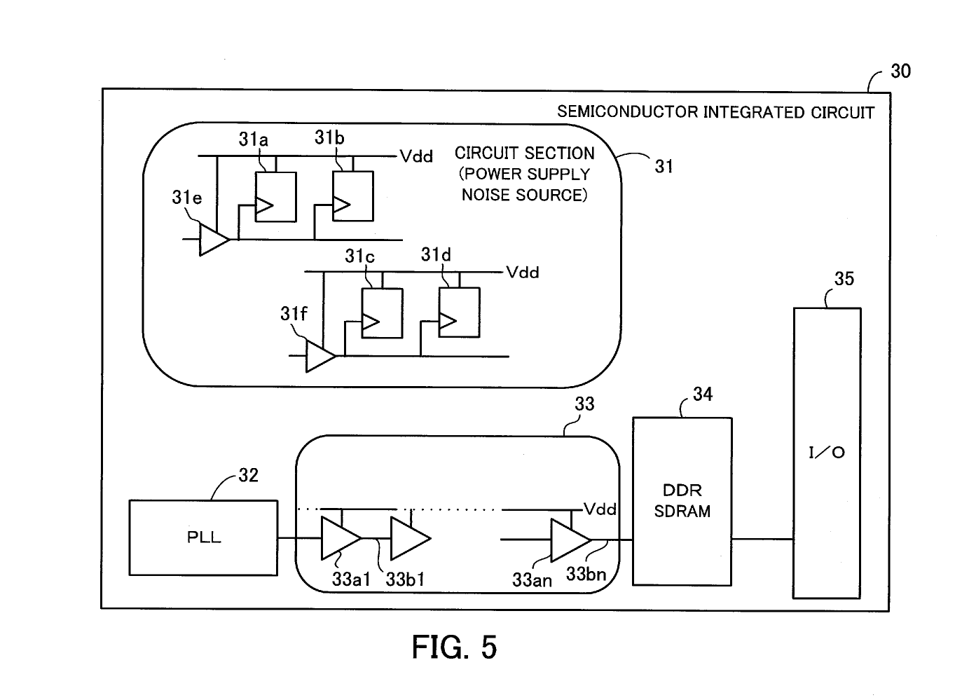

FIG. 5 illustrates an example of a semiconductor integrated circuit including a clock path to be designed.

A semiconductor integrated circuit 30 includes a circuit section 31, a PLL (Phase Locked Loop) 32, a clock path 33, a DDR SDRAM (Double Data Rate Synchronous Dynamic Random Access Memory) 34, and an I/O (Input/Output) 35.

The circuit section 31 is a power supply noise source. In the example of FIG. 5, the circuit section 31 is a synchronous circuit including flip-flops 31a, 31b, 31c, and 31d. The flip-flops 31a, 31b, 31c, and 31d operate on the basis of power-supply voltage Vdd and clocks inputted via clock buffers 31e and 31f. For example, power supply noise is caused by the operation of the flip-flop 31a, 31b, 31c, or 31d.

The PLL 32 generates a clock at a determined frequency.

The clock path 33 includes clock buffers 33a1 through 33an and wiring loads 33b1 through 33bn connected to the clock buffers 33a1 through 33an, respectively, and propagates a clock generated by the PLL 32.

The DDR SDRAM 34 is an example of a synchronous circuit and performs determined operation in synchronization with a clock inputted via the clock path 33.

The I/O 35 outputs data read out from the DDR SDRAM 34 or supplies to the DDR SDRAM 34 data inputted from the outside. The I/O 35 may output a clock generated by the PLL 32 via the clock path 33 and the DDR SDRAM 34.

If power supply noise is caused in the circuit section 31 of the above semiconductor integrated circuit 30, then the clock path 33 may be influenced by the power supply noise and a path delay may increase. The following design method is used for designing the clock path 33 on which great delay fluctuations are not caused by power supply noise, that is to say, which has high power supply noise resistance.

(Example of Design Method)

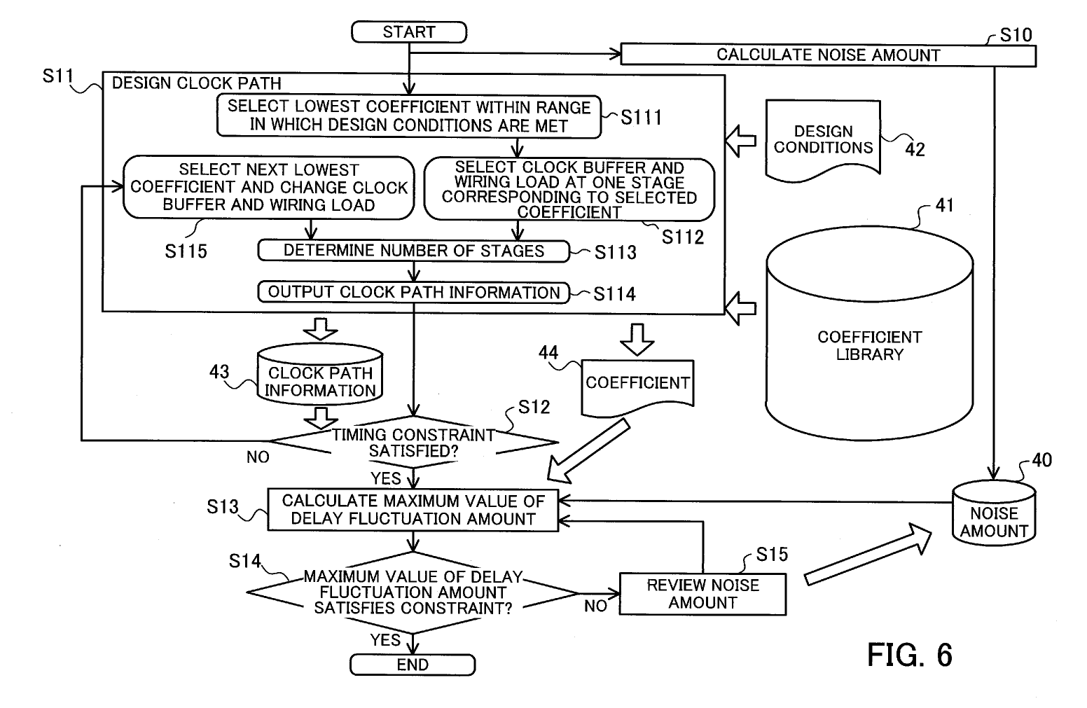

FIG. 6 is a flow chart for describing the flow of an example of a design method according to the second embodiment.

The following process is performed by the computer 20 illustrated in FIG. 4 under the control of the processor 21. With a design method according to the second embodiment, it is assumed that a coefficient library like that described in the first embodiment is generated in advance and that the coefficient library is stored in, for example, the HDD 23.

First each step will be described briefly.

For example, first the amount of power supply noise in a semiconductor integrated circuit is calculated (step S10) and a calculated noise amount 40 is stored in, for example, the HDD 23.

After that, a clock path is designed (step S11). Step S11 includes, for example, the following steps S111, S112, S113, S114, and S115.

In step S111, the lowest coefficient is selected from a coefficient library 41 in a range in which design conditions 42 are met.

In step S112, a clock buffer and a wiring load at one stage corresponding to the selected coefficient are selected.

In step S113, the number of stages on the clock path at which cells each including the clock buffer and the wiring load are arranged is determined on the basis of selection results of the clock buffer and the wiring load and wiring length of the clock path included in the design conditions 42.

In step S114, clock path information 43 (including the number of the stages on the clock path) is outputted. The clock path information 43 is stored in, for example, the HDD 23.

When the determination that a timing constraint is not satisfied is made at the time of performing timing constraint confirmation described later, step S115 is performed. In this case, the clock buffer or the wiring load is changed. For example, the next lowest coefficient to the coefficient selected in step S111 is selected and a clock buffer and a wiring load at one stage each having a parameter corresponding to the next lowest coefficient are used.

The timing constraint confirmation is performed after step S11 (step S12). In step S12, whether or not the designed clock path satisfies the timing constraint is determined. If the designed clock path does not satisfy the timing constraint, then step S115 is performed.

If the designed clock path satisfies the timing constraint, then a maximum value of a delay fluctuation amount is calculated (step S13). A maximum value of a delay fluctuation amount is found from the above expression (1) on the basis of the noise amount 40 and the coefficient 44 selected in step S111 or step S115.

After that, whether or not the maximum value of a delay fluctuation amount calculated in step S13 satisfies a constraint on a synchronous circuit to which the clock path is connected is confirmed (step S14). If the maximum value of a delay fluctuation amount calculated in step S13 does not satisfy the constraint on the synchronous circuit to which the clock path is connected, then the noise amount 40 is reviewed (step S15). In step S15, for example, the noise amount 40 is recalculated and is updated. After that, the process is repeated from step S13. After a redesign is made to reduce the noise amount 40, the process may be repeated from step S10.

If the determination that the maximum value of a delay fluctuation amount calculated in step S13 satisfies the constraint on the synchronous circuit to which the clock path is connected is made in step S14, then the design process indicated in FIG. 6 ends.

The order of these steps is not limited to the above order. For example, step S10 in which the amount of power supply noise is calculated may be performed just before step S13 in which a maximum value of a delay fluctuation amount is calculated.

An example of each of steps S10, S11, and S12 will now be described.

(Noise Amount Calculation (Step S10))

For example, a noise amount is calculated from a DvD (Dynamic voltage Drop) analysis result, clock latency, and a DvD peak constraint for a semiconductor integrated circuit designed before. For example, the processor 21 acquires a DvD analysis result and a power-supply voltage waveform of a clock path and calculates a noise amount, as illustrated in FIG. 2, by integrating a voltage drop from the power-supply voltage Vdd by time (from T0 to T1) for which noise appears.

(Clock Path Design (Step S11))

The processor 21 acquires the coefficient library 41 and the design conditions 42 stored in, for example, the HDD 23 and performs steps S111 through S115. For example, the design conditions 42 include wiring length of the clock path, the type of a clock buffer (transistor sizes, transistor threshold voltages, and the like differ among different types) and wiring conditions in addition to a timing constraint and a delay fluctuation constraint on the clock path.

The wiring conditions are usable wiring layers, wiring lengths, wiring widths, intervals between adjacent wirings, and the like and depend on process technologies.

As stated above, a coefficient managed by the coefficient library 41 is expressed as

voltage sensitivity (Ds)/delay time (D),

for a cell which is a combination of a clock buffer and a wiring load each having a parameter. Ds is given by

Ds=ΔD/ΔV,

where ΔD indicates the amount of an increase in delay time and ΔV indicates the magnitude of a voltage drop.

The relationship between the amount of an increase in delay time and the magnitude of a voltage drop is, for example, as follows.

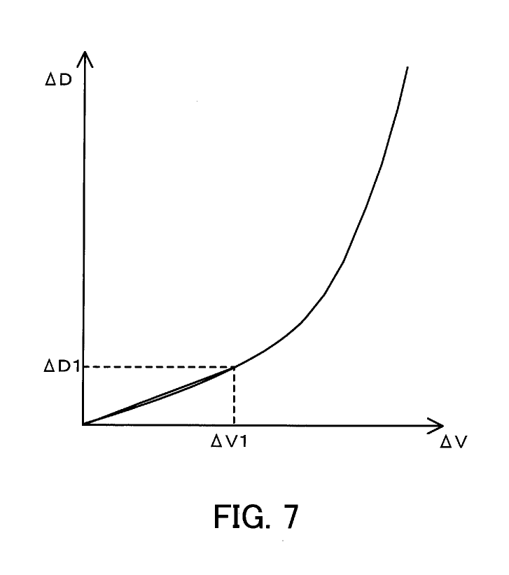

FIG. 7 indicates an example of the relationship between the amount of an increase in delay time and the magnitude of a voltage drop.

In FIG. 7, a horizontal axis indicates the magnitude (ΔV) of a voltage drop and a vertical axis indicates the amount (ΔD) of an increase in delay time.

As indicated in FIG. 7, there is a nonlinear relationship between the amount of an increase in delay time and the magnitude of a voltage drop and an increase in voltage drop causes a rapid increase in the amount of an increase in delay time. In this embodiment it is assumed that the processor 21 calculates voltage sensitivity from the magnitude ΔV1 of a voltage drop and the amount ΔD1 of an increase in delay time corresponding thereto in a region in which the relationship between the amount of an increase in delay time and the magnitude of a voltage drop is considered to be comparatively linear.

Delay time (D) and ΔD1 corresponding to the voltage drop ΔV1 are obtained by, for example, a circuit simulation for each combination of a clock buffer having a parameter and a wiring load having a parameter. Furthermore, for example, the following coefficient library 41 is obtained from a group of coefficients calculated on the basis of these values.

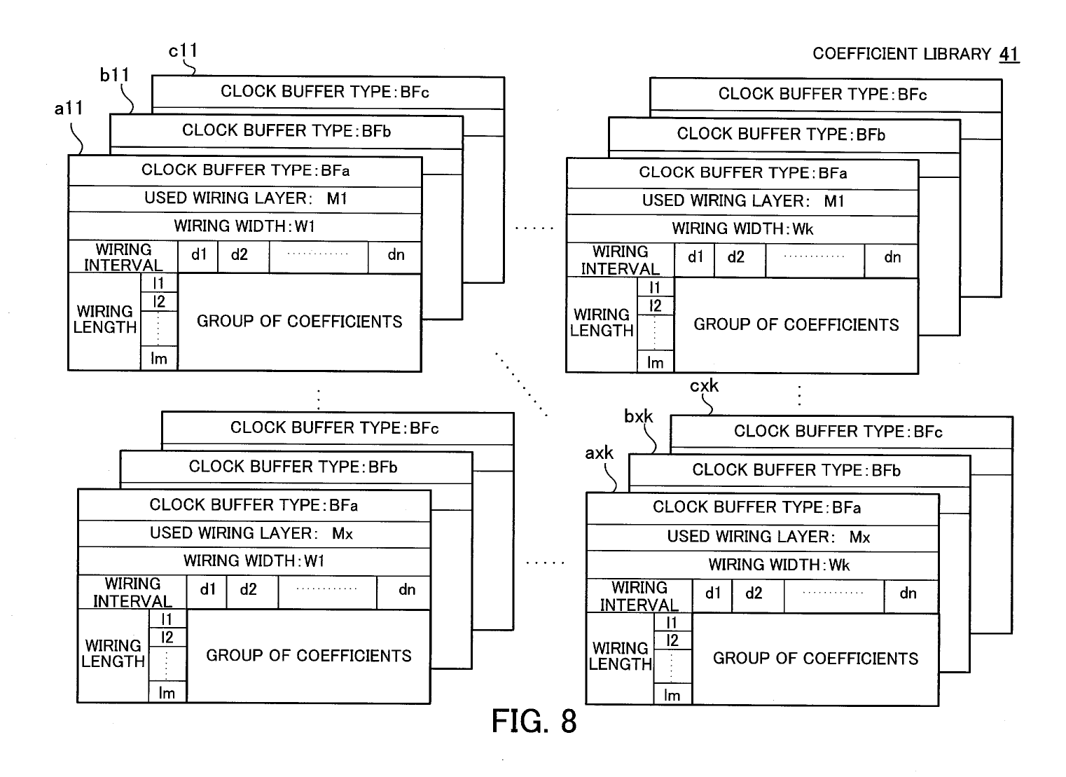

FIG. 8 illustrates an example of a coefficient library.

For example, the coefficient library 41 includes a plurality of tables a11, b11, c11 through axk, bxk, and cxk. Coefficients are managed according to combinations of plural parameters.

With the table a11, a group of coefficients corresponding to wiring intervals (d1, d2, . . . , and dn) and wiring lengths (l1, l2, . . . , and lm) are managed for the clock buffer type “BFa”, the used wiring layer “M1”, and the wiring width “W1”. Furthermore, with the table b11, a group of coefficients corresponding to wiring intervals (d1, d2, . . . , and dn) and wiring lengths (l1, l2, . . . , and lm) are managed for the clock buffer type “BFb”, the used wiring layer “M1”, and the wiring width “W1”. In addition, with the table c11, a group of coefficients corresponding to wiring intervals (d1, d2, . . . , and dn) and wiring lengths (l1, l2, . . . , and lm) are managed for the clock buffer type “BFc”, the used wiring layer “M1”, and the wiring width “W1”.

Similarly, groups of coefficients obtained by changing a used wiring layer in the range of M1 to Mx and changing wiring width in the range of W1 to Wk are managed by the tables a11, b11, c11 through axk, bxk, and cxk.

The number of the types of clock buffers is not limited to three. There may be clock buffers of four or more types or two types.

In step S111, a table which meets the design conditions 42 is selected from, for example, the above coefficient library 41 and the lowest coefficient is selected from a group of coefficients managed by the table.

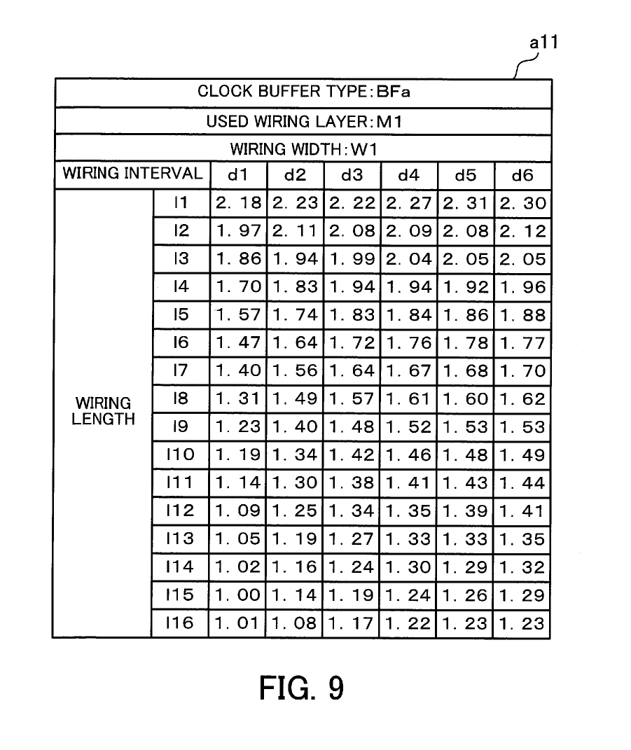

FIG. 9 illustrates an example of a group of coefficients.

FIG. 9 illustrates an example of the group of coefficients included in the table all illustrated in FIG. 8. This group of coefficients is obtained by changing a wiring interval in the range of d1 to d6 and changing wiring length in the range of l1 to l16. The narrowest wiring interval is “d1” and the widest wiring interval is “d6”. The shortest wiring length is “l1” and the longest wiring length is “l16”. In the example of FIG. 9, a coefficient corresponding to the wiring interval “d1” and the wiring length “l15” is the lowest.

Accordingly, if the table a11 illustrated in FIG. 9 is selected in step S111 and “d1” and “l15” meet the design conditions 42, then the coefficient corresponding to “d1” and “l15” is selected.

In step S112, a clock buffer and a wiring load each having a parameter corresponding to the selected coefficient are selected. In the above example, a clock buffer whose type is “BFa” is selected. In addition, a wiring load whose used wiring layer is “M1”, whose wiring width is “W1”, whose wiring interval is “d1”, and whose wiring length is “l15” is selected.

On the basis of the clock buffer and the wiring load selected in the above way and the wiring length of the clock path included in the design conditions 42, the number of stages on the clock path at which cells each including the clock buffer and the wiring load are arranged is determined (step S113) and the clock path information 43 is outputted (step S114).

In this embodiment it is assumed that the clock path is designed by arranging at plural stages the same cells each including the clock buffer and the wiring load selected in step S112.

The reason for this will now be described.

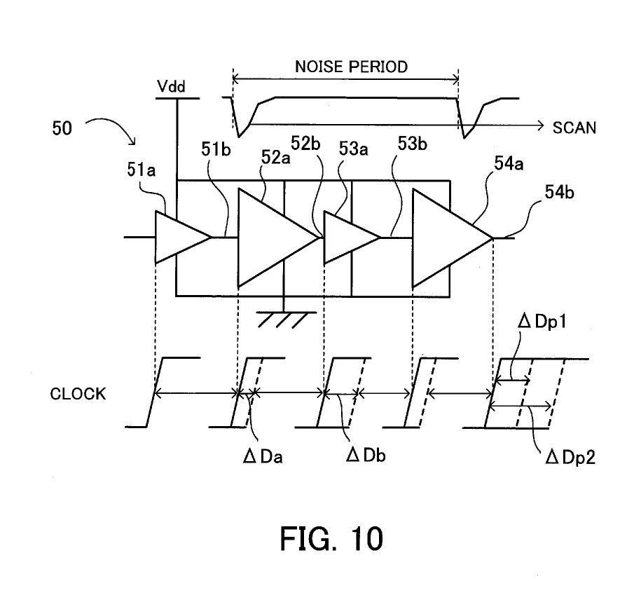

FIG. 10 illustrates an example of the state of fluctuations in path delay at the time of the occurrence of noise on a clock path using clock buffers of plural types and wiring loads of plural types.

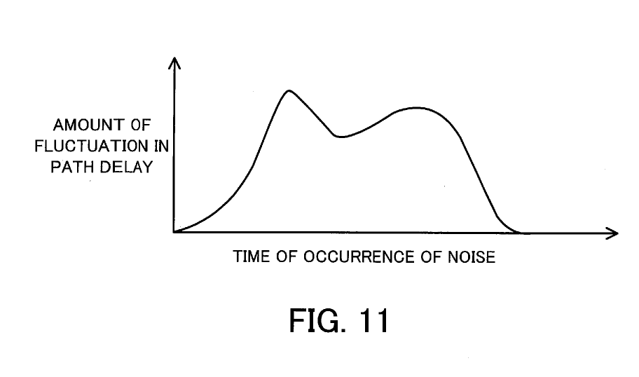

Furthermore, FIG. 11 illustrates an example of the relationship between the time of the occurrence of noise and the amount of a fluctuation in path delay on a clock path using clock buffers of plural types and wiring loads of plural types. In FIG. 11, a horizontal axis indicates the time of the occurrence of noise and a vertical axis indicates the amount of a fluctuation in path delay.

As illustrated in FIG. 10, a clock path 50 includes clock buffers 51a, 52a, 53a, and 54a of plural types and wiring loads 51b, 52b, 53b, and 54b of plural types. In the example of FIG. 10, the state of a fluctuation in path delay at the time of scanning the time of the occurrence of noise having a period in the direction of an arrow is illustrated. For example, if noise occurs about the time when a clock reaches the clock buffer 52a, then delay time changes by ΔDa. If noise occurs about the time when a clock reaches the clock buffer 53a, then delay time changes by ΔDb. The amount of a change in delay time at each stage differs, so the amount of a fluctuation in path delay becomes ΔDp1 or ΔDp2 and fluctuates.

That is to say, if the same clock buffer and wiring load are not used at each stage, the amount of a fluctuation in path delay fluctuates, as illustrated in FIG. 11, according to, for example, the time of the occurrence of noise.

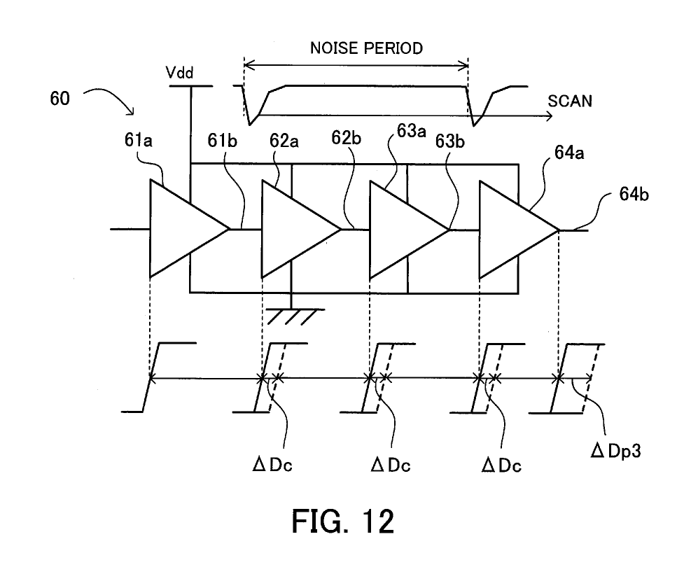

FIG. 12 illustrates an example of the state of a fluctuation in path delay at the time of the occurrence of noise on a clock path using clock buffers of the same type and wiring loads of the same type.

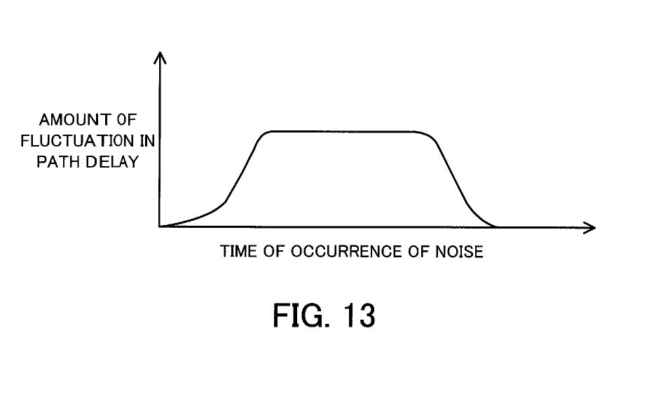

Furthermore, FIG. 13 illustrates an example of the relationship between the time of the occurrence of noise and the amount of a fluctuation in path delay on a clock path using clock buffers of the same type and wiring loads of the same type. In FIG. 13, a horizontal axis indicates the time of the occurrence of noise and a vertical axis indicates the amount of a fluctuation in path delay.

As illustrated in FIG. 12, a clock path 60 includes clock buffers 61a, 62a, 63a, and 64a of the same type (each having the same parameter) and wiring loads 61b, 62b, 63b, and 64b of the same type (each having the same parameters). In the example of FIG. 12, the state of a fluctuation in path delay at the time of scanning the time of the occurrence of noise having a period in the direction of an arrow is illustrated.

In the example of FIG. 12, the clock buffers 61a, 62a, 63a, and 64a arranged at stages are of the same type and the wiring loads 61b, 62b, 63b, and 64b arranged at the stages are of the same type. Accordingly, the amount of a change in delay time at each stage is ΔDc regardless of the time of the occurrence of noise, so the amount of a fluctuation in path delay is also constant (ΔDp3).

That is to say, if the same clock buffer and wiring load are used at each stage, variation in the amount of a fluctuation in path delay is controlled as illustrated in FIG. 13. Therefore, jitter is controlled.

The reason for designing the clock path by arranging at plural stages the same cells each including the clock buffer and the wiring load selected in step S112 has been described.

When the determination that the timing constraint is not satisfied is made at the time of performing timing constraint confirmation described later, step S115 is performed. In this case, the clock buffer or the wiring load is changed. For example, the next lowest coefficient to the coefficient selected in step S111 is selected and a clock buffer and a wiring load at one stage corresponding to the next lowest coefficient are selected. In the example of FIG. 9, the next lowest coefficient to the coefficient “1.00” is “1.01”, so a wiring load having as parameters the wiring length “l16” and the wiring interval “d1” associated with the coefficient “1.01” is selected.

(Timing Constraint Confirmation (Step S12))

If the lowest coefficient is selected in step S111, a clock path formed by the use of a clock buffer and a wiring load each having a parameter associated with the lowest coefficient has high noise resistance. However, a low coefficient tends to lead to long delay time.

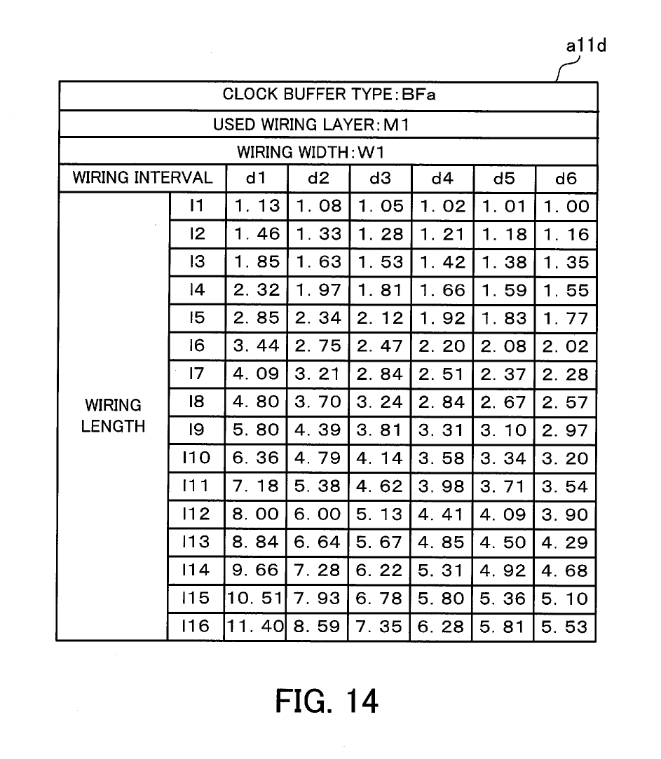

FIG. 14 illustrates an example of the length of delay time corresponding to parameters.

With a table a11d illustrated in FIG. 14, an example of delay time corresponding to the same parameters that are included in the table a11 illustrated in FIG. 9 is indicated.

As stated above, with the table a11 illustrated in FIG. 9, the coefficient corresponding to the wiring length “l15” and the wiring interval “d1” is the lowest. With the table a11d illustrated in FIG. 14, however, delay time corresponding to the wiring length “l15” and the wiring interval “d1” is comparatively long. As a result, a clock path formed by arranging cells each having these parameters at plural stages and connecting them may not satisfy the timing constraint.

Accordingly, whether or not the clock path designed in step S11 satisfies the timing constraint included in the design conditions 42 is confirmed in step S12.

The processor 21 performs a STA (Static Timing Analysis) for confirming whether or not the clock path satisfies the timing constraint. The timing constraint on the clock path includes whether or not clock pulse width is enough and a clock latency (clock delay) constraint. These constraint conditions are determined by the specifications for a chip to be developed. Input for a STA includes, for example, a cell delay library and the clock path information 43 (information indicative of the number of the stages on the clock path).

If the timing constraint is not satisfied, then step S115 is performed. If the timing constraint is satisfied, then step S13 is performed. If a low coefficient is used, delay time becomes long. Therefore, by performing steps S12 and S115, the clock path satisfies the timing constraint.

As has been described, with the design method according to this embodiment, the lowest possible coefficient is selected in a range in which the design conditions 42 are met and a clock path is designed by the use of a clock buffer and a wiring load each having a parameter associated with the selected coefficient. The coefficient expresses an increase in delay time at the time of voltage drop. Accordingly, this makes it possible to design a clock path on which an increase in delay time is slight at the time of a voltage drop caused by power supply noise, that is to say, a clock path on which great delay fluctuations are not caused by power supply noise (which has high power supply noise resistance).

Furthermore, a clock path having high power supply noise resistance is designed in the design phase. Otherwise, delay fluctuations on a clock path are verified by a circuit simulator after a placement and routing process and a placement and routing process is performed again on the basis of a verification result to make a correction. With the design method according to this embodiment such trouble is saved.

In the second embodiment the description has been given on the assumption that the coefficient library 41 is generated in advance. However, the design apparatus (computer 20) which performs the process illustrated in FIG. 6 may generate the coefficient library 41. This is the same with the design method according to the first embodiment. Furthermore, the design apparatus may acquire the coefficient library 41 generated by another apparatus to perform the process illustrated in FIG. 6.

In addition, in step S111 the lowest coefficient is selected from the coefficient library 41 in a range in which the design conditions 42 are met. However, there is no need to always select the lowest coefficient. If a low coefficient is preferentially selected, a clock path having high noise resistance can be designed.

In addition, in the above description a cell at one stage is obtained by combining a clock buffer and a wiring load connected to its output side. However, a clock buffer and a wiring load connected to its input side may be combined.

The design method, the design apparatus, and the program according to the present invention have been described on the basis of the embodiments. However, these embodiments are simple examples and the present invention is not limited to the above description.

According to the disclosed design method, design apparatus, and program, a clock path having high power supply noise resistance is designed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A design method comprising:
preferentially selecting, by a processor, a low coefficient in a range in which design conditions are met from a group of coefficients indicative of an increase in delay time at a time of voltage drop for combinations of one of a plurality of clock buffers which differ in parameter and one of a plurality of wiring loads, which differ in parameter, connected to the one of the plurality of clock buffers; and
selecting, by the processor, from the plurality of clock buffers and the plurality of wiring loads a clock buffer and a wiring load each having a parameter associated with the selected coefficient, and designing, by the processor, a clock path.

2. The design method according to claim 1, further comprising repeatedly arranging, by the processor, the selected clock buffer and the selected wiring load on the clock path on the basis of length of the clock path.

3. The design method according to claim 1, wherein a coefficient of the group of coefficients for a combination of one of the plurality of clock buffers and one of the plurality of wiring loads is calculated by dividing an amount of an increase in delay time to magnitude of a voltage drop by delay time.

4. The design method according to claim 1, further comprising calculating, by the processor, an amount of an increase in delay time to magnitude of a voltage drop and delay time for each of combinations of one of the plurality of clock buffers which differ in parameter and one of the plurality of wiring loads which differ in parameter, and calculating, by the processor, a coefficient of the group of coefficients by dividing the amount of an increase in delay time to the magnitude of a voltage drop by the delay time.

5. The design method according to claim 1, wherein a lowest coefficient is selected by the processor from the group of coefficients in a range in which a timing condition of the clock path included in the design conditions is met.

6. A design apparatus comprising a processor which:
preferentially selects a low coefficient in a range in which design conditions are met from a group of coefficients indicative of an increase in delay time at a time of voltage drop for combinations of one of a plurality of clock buffers which differ in parameter and one of a plurality of wiring loads, which differ in parameter, connected to the one of the plurality of clock buffers; and
selects from the plurality of clock buffers and the plurality of wiring loads a clock buffer and a wiring load each having a parameter associated with the selected coefficient, and designs a clock path.

7. A computer-readable, non-transitory record medium storing a program which makes a computer:
preferentially select a low coefficient in a range in which design conditions are met from a group of coefficients indicative of an increase in delay time at a time of voltage drop for combinations of one of a plurality of clock buffers which differ in parameter and one of a plurality of wiring loads, which differ in parameter, connected to the one of the plurality of clock buffers; and
select from the plurality of clock buffers and the plurality of wiring loads a clock buffer and a wiring load each having a parameter associated with the selected coefficient, and design a clock path.
